(19) United States
(12) Patent Application Publication
(10) Pub. No.: US 2016/0231854 A1
(43) Pub. Date: Aug. 11, 2016

(54) ORTHOGONAL FREQUENCY DIVISION SCANNING METHOD FOR SENSORS

(71) Applicant: Qualcomm Technologies, Inc., San Diego, CA (US)

(72) Inventor: Ronald B. Koo, Los Altos, CA (US)

(21) Appl. No.: 15/016,112

(22) Filed: Feb. 4, 2016

Related U.S. Application Data
(60) Provisional application No. 62/112,778, filed on Feb. 6, 2015.

(51) Int. Cl. G06F 3/041; G06F 3/044; G06F 3/047; G06F 3/0354

(52) U.S. Cl. CPC G06F 3/0416; G06F 3/03545; G06F 3/044; G06F 3/047

(57) ABSTRACT

In embodiments, an apparatus includes a controller configured to operatively couple to a sensor (e.g., a touch panel sensor, a fingerprint sensor). The sensor includes a plurality of drive electrodes and a plurality of sense electrodes. Nodes are formed at the intersections of the plurality of drive electrodes and the sense electrodes. The controller includes output circuitry operatively coupled to the plurality of drive electrodes. The output circuitry is configured to generate unique drive signals to drive corresponding drive electrodes of touch panel sensor. The touch panel controller also includes input circuitry operatively coupled to the sense electrodes. The input circuitry is configured to measure mutual-capacitance formed at each intersection of the plurality of drive electrodes to create an image of one or more objects proximate to the sensor.

### PRIORITY CLAIM

This application claims priority to U.S. Provisional Patent Application No. 62/112,778, filed on Feb. 6, 2015 and entitled “ORTHOGONAL FREQUENCY DIVISION SCANNING METHOD FOR SENSORS,” which is hereby incorporated by reference.

### BACKGROUND

A touch panel is a human machine interface (HMI) that allows an operator of an electronic device to provide input to the device using an instrument such as a finger, a stylus, and so forth. For example, the operator may use his or her finger to manipulate images on an electronic display, such as a display attached to a mobile computing device, a personal computer (PC), or a terminal connected to a network. In some cases, the operator may use two or more fingers simultaneously to provide unique commands, such as a zoom command, executed by moving two fingers away from one another; a shrink command, executed by moving two fingers toward one another; and so forth.

A touch screen is an electronic visual display that incorporates a touch panel overlying a display to detect the presence and/or location of a touch within the display area of the screen. Touch screens are common in devices such as all-in-one computers, tablet computers, satellite navigation devices, gaming devices, media devices, and smartphones. A touch screen enables an operator to interact directly with information that is displayed by the display underlying the touch panel, rather than indirectly with a pointer controlled by a mouse or touchpad. Capacitive touch panels are often used with touch screen devices. A capacitive touch panel generally includes an insulator, such as glass, coated with a transparent conductor, such as indium tin oxide (ITO). As the human body is also an electrical conductor, touching the surface of the panel results in a distortion of the panel's electrostatic field, measurable as a change in capacitance.

A fingerprint sensor is an electronic device used to capture a digital image of a fingerprint pattern (e.g., a live scan of a fingerprint). The live scan can be utilized to create a biometric template, which can be stored and utilized for matching purposes.

### SUMMARY

In embodiments, an apparatus includes a controller configured to operatively couple to a sensor (e.g., a touch panel sensor, a fingerprint sensor). The sensor includes a plurality of drive electrodes and a plurality of sense electrodes. Nodes (“pixels”) are formed at the intersections of the plurality of drive electrodes and the sense electrodes. The controller includes output circuitry operatively coupled to the plurality of drive electrodes. The output circuitry is configured to generate unique drive signals to drive corresponding drive electrodes of the sensor. The controller also includes input circuitry operatively coupled to the sense electrodes. The input circuitry is configured to measure mutual-capacitance formed at each intersection of the plurality of drive electrodes and the plurality of sense electrodes to create an image of one or more objects proximate to the sensor.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. The use of the same reference numbers in different instances in the description and the figures may indicate similar or identical items.

FIG. 1 is a block diagram illustrating a touch panel sensor system in accordance with an example implementation of the present disclosure.

FIG. 2 a block diagram illustrating a touch panel sensor system, where a touch event is being performed over a touch sensor.

FIGS. 3 and 4 are diagrammatic graphs illustrating various drive signal amplitudes vs. the drive signal frequencies, where FIG. 3 illustrates amplitudes having no touch events performed over the touch sensor and FIG. 4 illustrates amplitudes in accordance with the touch event illustrated in FIG. 2.

FIG. 5 a block diagram illustrating a touch panel sensor system, where a touch event is being performed over a touch sensor.

FIGS. 6 and 7 are diagrammatic graphs illustrating various drive signal amplitudes vs. the drive signal frequencies, where FIG. 6 illustrates amplitudes having no touch events performed over the touch sensor and FIG. 7 illustrates amplitudes in accordance with the touch event illustrated in FIG. 5.

FIG. 8 is a block diagram illustrating a touch panel sensor system in accordance with another example implementation of the present disclosure, where a frequency generator is configured to generate driving signals having frequency characteristics in an interleaved fashion.

FIG. 9 is a block diagram illustrating a touch panel sensor system in accordance with another example implementation of the present disclosure, where a frequency generator is configured to generate driving signals having carrier frequency.

FIG. 10 is a block diagram illustrating a touch panel sensor system in accordance with another example implementation of the present disclosure, where a stylus is performing a touch event over the touch sensor.

FIGS. 11 through 13 illustrate various diagrammatic data transmission protocols in accordance with an example implementation of the present disclosure.

### DETAILED DESCRIPTION

Overview

Typically, measuring the mutual capacitance at the intersection of transmitter and receiver lines on a touch sensor is to scan one row at a time down the sensor. If the touch sensor has to update at 100 frames per second (fps) and if there are 50 rows to scan in each frame, then each row has only 200 μs (1/[(100 fps)(50 rows)]. In some measuring methods, multiple rows are driven at the same time. After the driving waveforms have propagated through the sensor pathways, the waveforms can be summed together at the input circuitry (e.g., a receiver) of the sensor.

Orthogonality of various drive signals can be used by a receiver to identify the change in each of the drive signals to determine how the impedances changed at each intersection. In the case of a touch sensor or a fingerprint sensor, each drive line of the sensor is driven by a drive signal having its own orthogonal signal. The signals can run continuously during the frame time, and the result is that the entire touch screen or fingerprint sensor is actively measuring capacitance changes.

In embodiments, an apparatus includes a controller configured to operatively couple to a sensor (e.g., a touch panel sensor, a fingerprint sensor). The sensor includes a plurality of drive electrodes and a plurality of sense electrodes. Nodes (“pixels”) are formed at the intersections of the plurality of drive electrodes and the sense electrodes. The controller includes output circuitry operatively coupled to the plurality of drive electrodes. The output circuitry is configured to generate unique drive signals to drive corresponding drive electrodes of touch panel sensor. The controller also includes input circuitry operatively coupled to the sense electrodes. The input circuitry is configured to measure the mutual-capacitance formed at each intersection of the plurality of drive electrodes and the plurality of sense electrodes to create an image of the object on the sensor. Additionally, further signal processing of the image can determine the location of a finger or unique characteristics associated with a fingerprint (e.g., unique ridge patterns, etc.) For example, as described above, each drive signal may have a frequency characteristic orthogonal to the frequency characteristics of other drive signals.

Thus, the receiver can measure the amplitude and/or the phase delay of the signals in order to determine how the impedance has changed along the path from the transmitter (e.g., output circuitry) to the receiver (e.g., input circuitry). Measurements are averaged together for greater accuracy.

Example Implementations

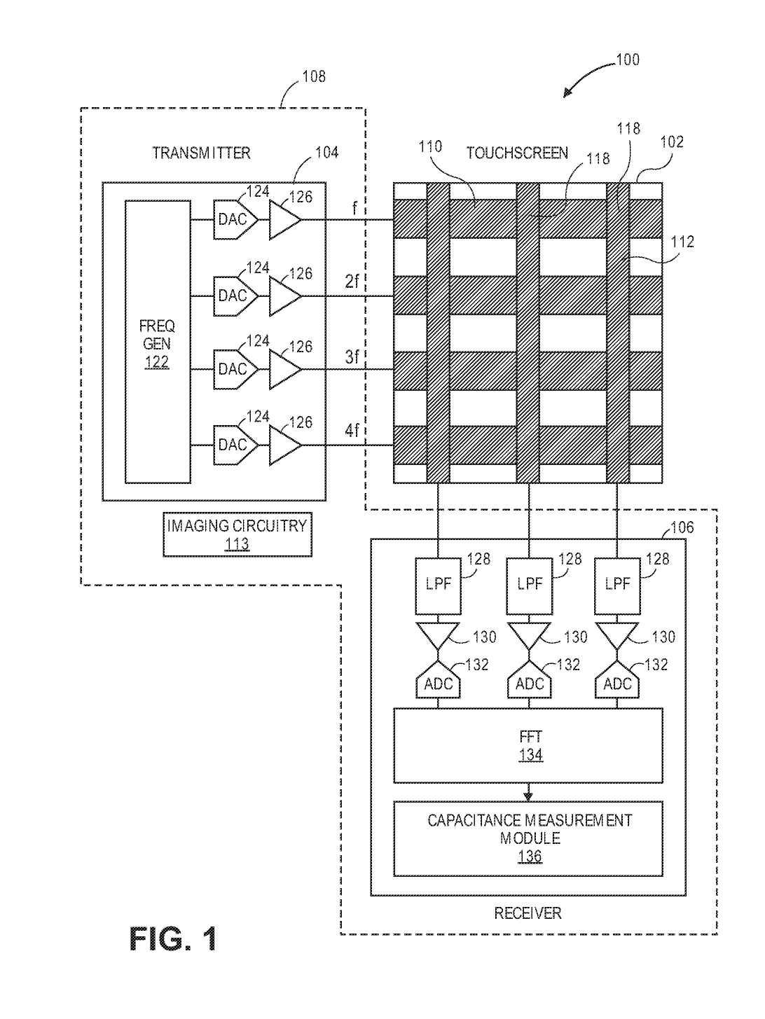

FIG. 1 illustrates a sensor system 100 in accordance with an example implementation of the present disclosure. In an implementation, the sensor system 100 comprises a touch panel sensor system. In another implementation, the sensor system 100 comprises a fingerprint sensor system. The sensor system 100 includes a sensor 102 (e.g., a touch panel sensor, a fingerprint sensor), output circuitry 104 (e.g., a transmitter having multiple sensor drivers), input circuitry 106 (e.g., a receiver), and a controller 108. As shown, the controller 108 is operatively connected (via a communication interface) to a sensor 102. In one or more implementations, the sensor 102 is utilized to image fingers and/or a palm over its surface. In another implementation, the sensor 102 is utilized to image the fingerprint ridges of a finger positioned over the sensor 102. For example, the sensor 102 can include a capacitive sensing medium having a plurality of row traces (e.g., electrodes), or drive lines 110, and a plurality of column traces (e.g., electrodes), or sense lines 112, for detecting a change in capacitance due to finger or palm over a surface of the panel. Accordingly, the terms “line,” “electrode” and “trace” may be used interchangeably herein. The controller 108 (utilizing imaging circuitry 113) can implement functionality to process the sensor image to determine the location of fingers and/or a palm. In one or more implementations, the controller 108 is configured to detect the presence of touch events (e.g., fingerprints, palms, etc.), stylus device events, and hover events.

In a specific implementation, the sensor 102 is a transparent panel positioned in front of or within a display device, such as a liquid crystal display, cathode ray tube, plasma displays, or the like. However, in other implementations, the display device and the touch panel sensor may be distinct (i.e., touch panel sensor is not positioned in front of the display device). The row and the column traces can be formed from a transparent conductive material, such as Indium Tin Oxide (ITO) or Antimony Tin Oxide (ATO), although other transparent and non-transparent materials, such as copper or silver, may be used. In some implementations, the row and the column traces can be perpendicular to each other such that the row and column traces define a coordinate system and each coordinate location comprises a capacitor formed at the intersection 118 of the row and column traces, as described in greater detail herein. In other implementations, other non-Cartesian orientations are also possible. As described above, the sensor system 100 is configured to detect touch events (e.g., fingerprints, palm), stylus events, and hover events.

The controller 108 is configured to interface with the sensor 102 to stimulate the sensor 102 (e.g., stimulate the drive lines) and to detect (e.g., read) the change in capacitance from the sense lines. In one or more implementations, the controller 108 comprises application specific integrated circuitry (ASIC) that is configured to drive the drive lines 110 (e.g., drive channels, drive electrodes). In an implementation, the controller 108 may comprise firmware and/or ASIC that provides processing functionality to the system 100.

As shown in FIG. 1, the controller 108 includes output circuitry 104 (e.g., a transmitter) configured to output drive signals having waveform characteristics. As shown, the output circuitry 104 comprises a frequency generator 122 for generating multiple signals having waveform characteristics. For example, the frequency generator 122 is configured to generate multiple signals having unique waveform (e.g., frequency) characteristics with respect to the waveform characteristics of the other signals. The frequency generator 122 is communicatively connected to multiple digital-to-analog converters 124 (DAC), and each DAC 124 is communicatively connected to a respective buffer 126. Each buffer 126 is electrically connected to a respective drive line 110. In an implementation, the output circuitry includes a number of DACs 124 and a number of buffers 126 that equal the number of drive lines 110. However, in some implementation, the sensor driver may comprise other suitable devices capable of producing driving signals.

The frequency generator 122 is configured to generate a unique signal for each respective drive line 110. For example, the frequency generator 122 is configured to generate a first signal for a first drive line 110 and configured to generate a second signal for a second drive line 110 (and so forth). In an implementation, the frequency generator 122 generates a signal having orthogonal frequency characteristics with respect to an adjacent signal. For example, a first signal driving a first drive line 110 may have orthogonal frequency characteristics with respect to a second signal that is driving a second drive line 110 (where the second drive line 110 is directly adjacent to the first drive line 110).

Each intersection 118 of the drive lines 110 (e.g., rows) and the sense lines 112 (e.g., columns) represents a pixel that has a characteristic mutual-capacitance. A grounded object (e.g., a finger, a stylus, etc.) that moves towards a corresponding pixel 118 may shunt an electric field present between the corresponding row and column intersection, which causes a decrease in the mutual-capacitance at that location. During operation, each row (or column) may be sequentially charged by driving (via the sensor drivers) the corresponding drive line 110 with a predetermined voltage signal having a waveform corresponding to a particular frequency characteristic. The capacitance of each intersection 118 is measured. That is, the sensing circuitry 106 is configured to measure capacitive coupling of the drive signals between the drive lines 110 and the sense lines 112 to determine the capacitance of an object with respect to each node (e.g., an intersection 118 pixel).

The controller 108 is configured to cause the frequency generator 122 to generate the drive signals for scanning (e.g., measure or determine the change in capacitance within) the sensor 102. For example, the controller 108 is configured to cause the output circuitry 104 to output signals having a predefined frequency characteristic (e.g., generate an output signal occurring within a predefined range of frequencies). The sensing circuitry 106 is configured to monitor (e.g., determine) the charge transferred in a given time to detect changes in capacitance at each node. The positions within the sensor 102 where the capacitance changes occur and the magnitude of those changes are used to image fingers and/or palms proximate (e.g., over) the sensor 102.

In some implementations, the sensing circuitry 106 (e.g., a receiver) may include low pass filters 128 (e.g., anti-alias filters) communicatively connected to respective sense lines 112. The low pass filters 128 are connected to respective buffers 130, and the buffers 130 are communicatively connected to respective analog-to-digital converters (ADCs) 132. The sensing circuitry 106 also includes a fast Fourier transform module 134, which is communicatively connected to the ADCs 132. The fast Fourier transform module 134, which computes the discrete Fourier transform in an efficient manner, converts the time data from the ADCs into its corresponding frequency representation. The fast Fourier transform module 134 is communicatively coupled to a capacitance measurement module 134. The drive signals contain unique frequencies, and the capacitance measurement module 134 monitors the changes in the amplitude of those frequencies to determine if the mutual capacitance has changed at any pixels on the sensor. Typically, the capacitance measurement module 134 determines a base measurement of the mutual capacitances when there is no object proximate to the sensor 102. A change in the mutual capacitance from the base measurement might indicate that an object is proximate (e.g., over, on, etc.) to the screen. Since there is usually a great deal of noise in the environment, the challenge is to decide whether the change in mutual capacitance is due to an object or noise.

The buffers 126 are configured to buffer the signal generated by the sensor DACs 124 and outputs the buffered drive signal to the sensor 102 (e.g., drive the drive lines 110 of the sensor 102). The DACs 124 are configured to convert the respective signal received from the frequency generator 122 to a corresponding analog signal. In implementations, the sensor DACs 124 may generate a signal having waveform characteristics represented by the equation:

A₁·sin(ωt), EQN. 1,

where A₁ represents the amplitude of the signal, ω represents the angular frequency of the signal, and t represents time. As described above, each DAC 124 generates a unique signal for the respective drive line. For example, the DAC 124 may generate a signal having orthogonal frequency characteristics with respect to the adjacent drive signals. In some implementations, the sensor DACs 124 may be configured to output sine waves. However, in other implementations, the sensor DACs 124 may be configured to output other signals having other waveform characteristics, such as square waves, wavelets, and so forth.

In one or more implementations, the system 100 is configured to measure a change in mutual-capacitance (C_{M}). The mutual-capacitance (C_{M}) is capacitance that occurs between two charge-holding objects (e.g., conductors). In this instance, the mutual-capacitance is the capacitance between the drive lines 110 and the sense lines 112 that comprise the sensor 102.

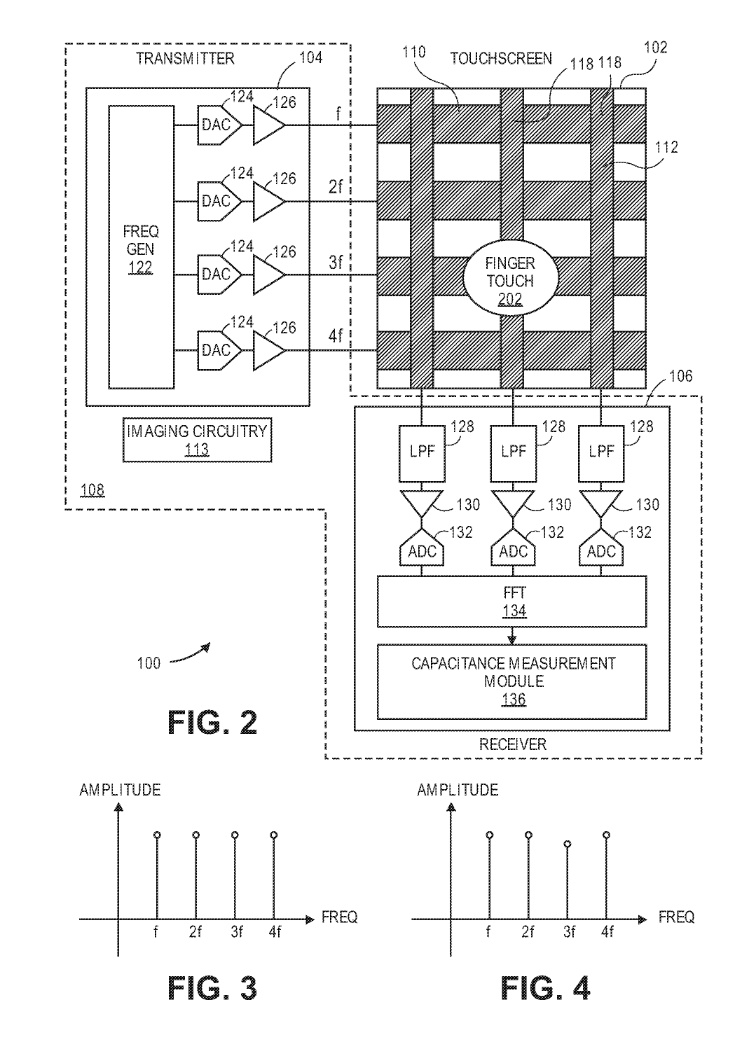

FIG. 2 illustrates an object 202 (e.g., a finger touch) performing a touch event over the sensor 102. As shown, each drive line 110 receives a unique drive signal (a signal having a different frequency characteristic) with respect to the other drive signals driving the other drive lines 110 (e.g., signals having frequency characteristics f through 4f). An object over the sensor 102 reduces the mutual capacitance between the drive line 110 and the sensing line 112, and hence, reduces the signal transferred across the two lines. For example, the drive line 110 associated with frequency characteristic 3f has a signal with a reduced amplitude with respect to the drive lines associated with frequency characteristics f, 2f, and 4f (see FIGS. 3 and 4). Thus, the capacitance measurement module 134 is configured to create an image of the objects (fingers, palm, etc.) proximate (e.g., a hover event, a touch event) to the surface of the sensor 102. The imaging circuitry can determine an approximate position of a touch event being performed over the sensor 102. For instance, the imaging circuitry is provided data of what drive signals are provided to what drive lines 110 and is configured to determine an approximate position based upon the modified signal (e.g., signal with frequency characteristic 3f). For example, the imaging circuitry can determine the approximate position since the capacitance measurement module 134 detects that the signal having frequency characteristic 3f has been modified (by the touch event) and the data indicating which drive line 110 was driven by the drive signal having frequency characteristic 3f has been provided to the imaging circuitry.

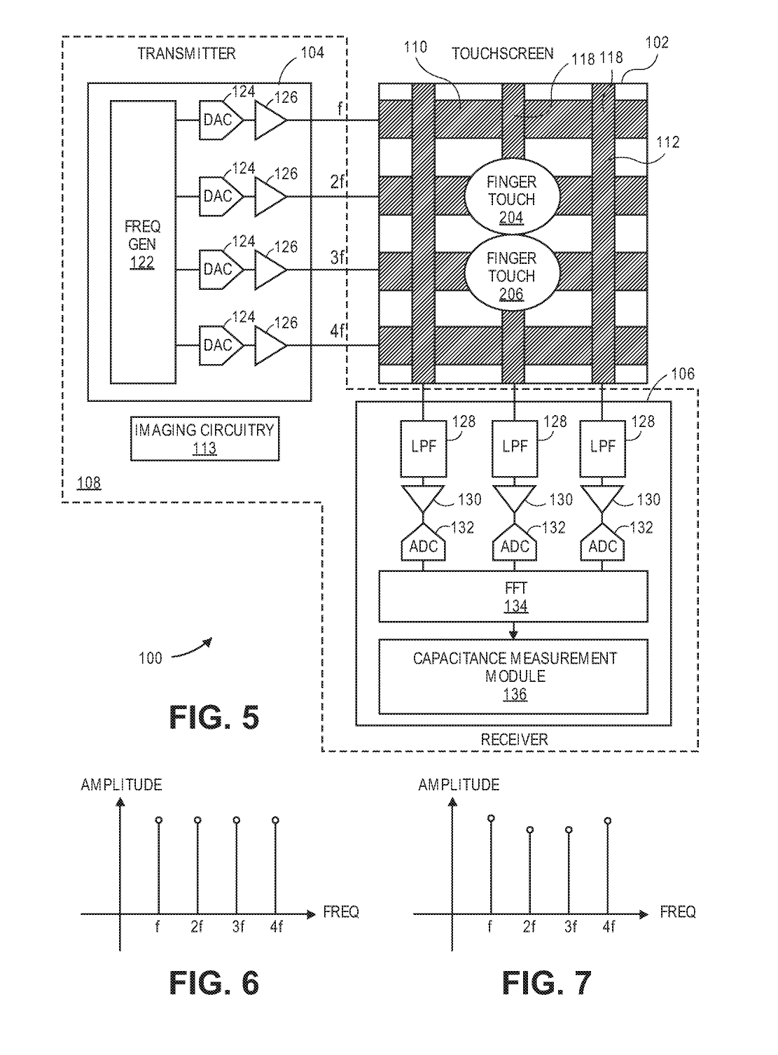

FIG. 5 illustrates objects 204, 206 over the sensor 102. In this example, the object 206 is over a drive line 110 associated with frequency characteristic 3f and another object is over the drive line 110 associated with frequency characteristic 2f. Thus, the amplitude characteristics of the drive signals having frequency characteristics 2f and 3f are modified with respects to the drive signals having frequency characteristics if and 4f (see FIGS. 6 and 7).

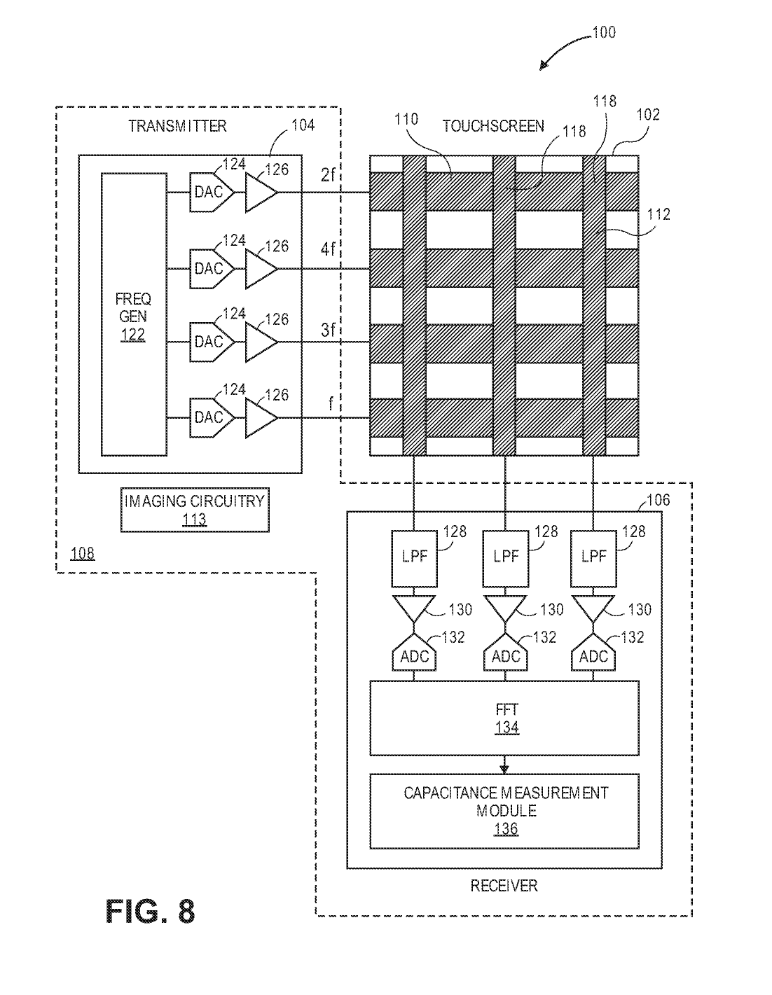

In some implementations, as shown in FIG. 8, the frequency generator 122 is configured to modify the frequency characteristics of the drive signals. For example, the frequency generator 122 may be configured to interleave the frequency characteristics driving the drive lines 110 on a predetermined basis such that the drive lines have the same approximate number of measurements taken during a sample period. These frequencies may also be modified in the event of external interference (e.g., interference from external signals). For instance, the frequency generator 122 can modify the frequency characteristics to a frequency that is outside of the band of interference.

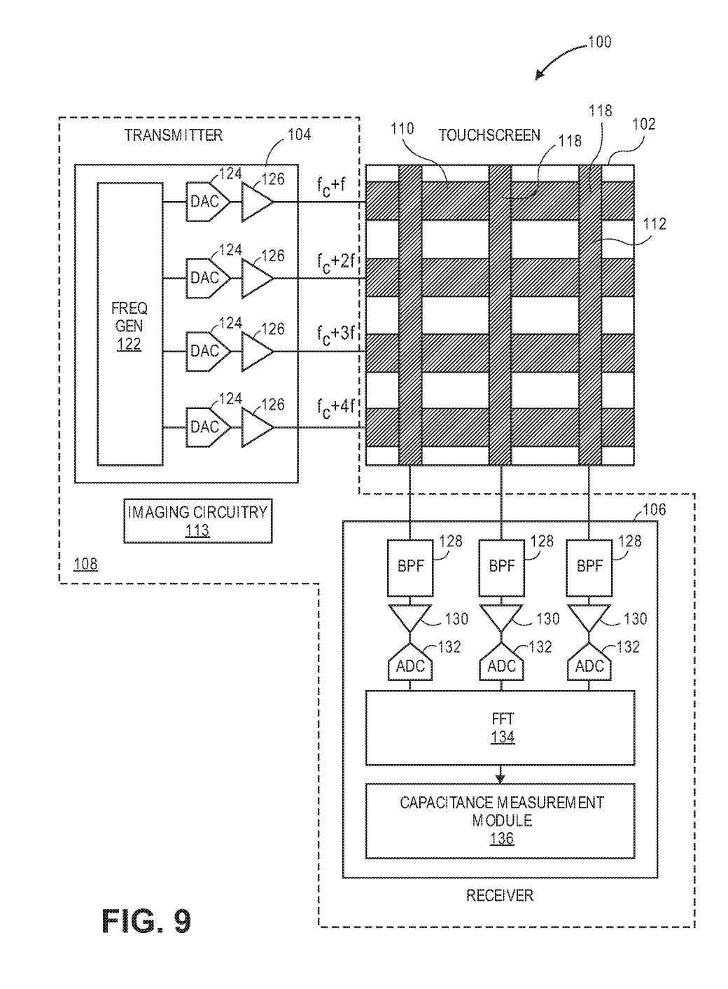

In one or more implementations, as shown in FIG. 9, the frequency generator 122 is configured to generate a drive signal that is modulated to a carrier frequency (f_{c}). For example, the frequency generator is configured to generate orthogonal drive signals having a carrier frequency characteristic that is below the 3 dB frequency of the sensor 102.

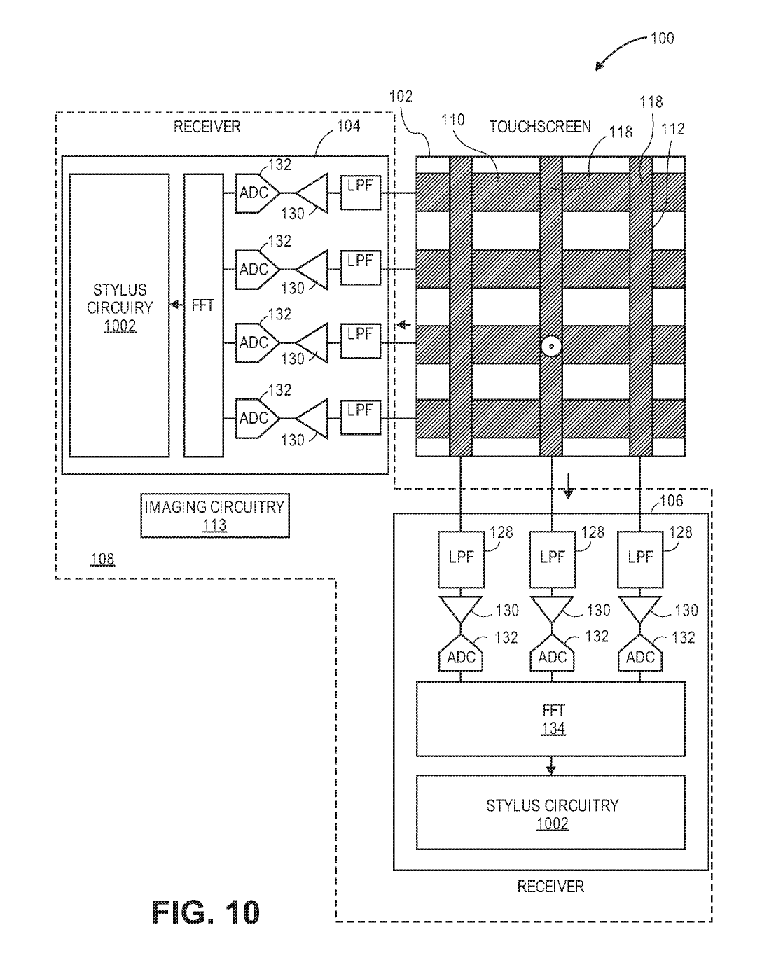

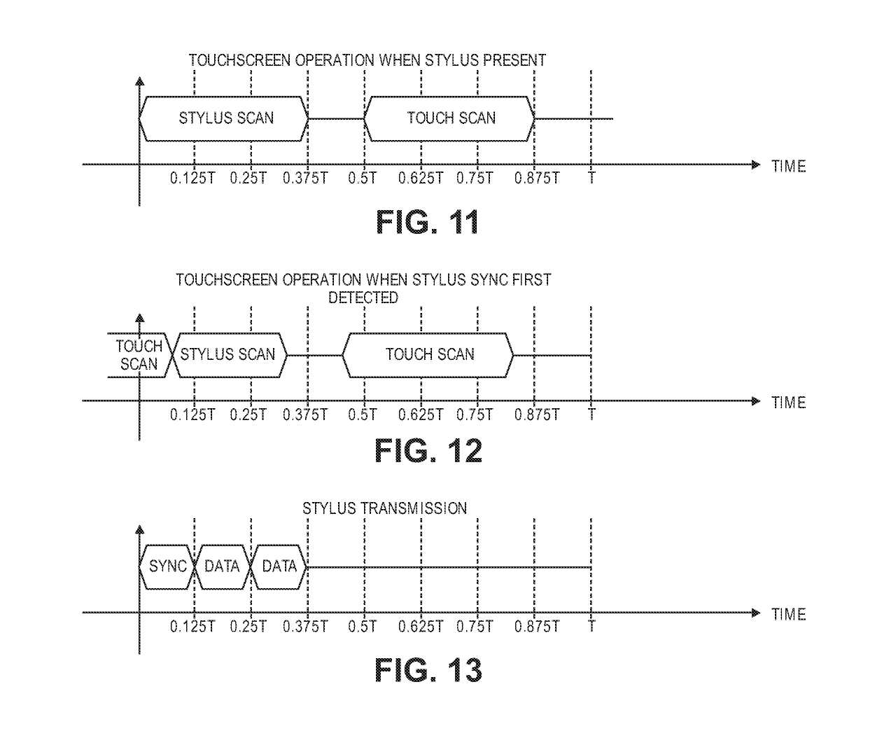

In one or more implementations, a stylus device may be utilized to write text, draw objects, select objects, manipulate objects move objects, etc. on the screen (see FIG. 10). In these implementations, the stylus device comprises a transmitter that transmits signal through an end of the stylus device (e.g., the tip of the stylus device). The stylus generates dedicated orthogonal signals (e.g., orthogonal signals different from the orthogonal signals assigned to the sensor). The pixels 118 are utilized to determine the location of the stylus device. For example, the sensor 102 may utilize time division multiplexing functionality to switch between touch imaging (described above) and stylus device imaging (see FIG. 11) within a period T. However, during stylus device imaging, the transmitter channels in the controller 108 are converted into receiver channels to determine a second coordinate of the stylus device (which includes a transmitter). The existing receiver channels are used to determine a first coordinate of the stylus device.

In implementations, the sensor 102 may be initially in touch detection mode (e.g., touch scan mode), as shown in FIG. 12. The stylus can transmit (e.g., broadcast) a sync signal (e.g., a forward error corrected code signal) (see FIG. 13) having a combination of orthogonal frequencies, which modifies the signals at the proximate pixels 118. The high-level stylus circuitry 1002 detects the presence of these stylus signals, which causes the controller 108 to conduct a stylus scan to locate the stylus device and receive data from the stylus device (see FIG. 12). After a buffer time, the controller 108 initiates a touch scan to image fingers. The controller 108 continues switching between stylus scan and touch scan as long as the stylus device is present. Once the stylus device moves out of range or stops transmitting, the controller 108 switches to touch scanning for as long as the stylus device is not present (e.g., not detected).

After the stylus device transmits the sync signal, it transmits data representing identity information, the state of the buttons associated with the stylus, battery level, tilt, and/or the pressure associated with the stylus device (see FIG. 13). The data can be coded onto the stylus device's dedicated orthogonal signals. Forward error correction can be included to improve the likelihood that correct data is decoded at the controller in the presence of internal or external noise.

Since the stylus device transmits and does not have a receive capability, the stylus device does not phase lock to an external signal. Therefore, the controller 108 can phase lock to the stylus device whenever the stylus device is present so that the controller 108 switches its transmitters to receivers in the part of the period when the stylus device is transmitting. The stylus device circuitry may have a phase locking method to align the timing of the controller with that of the stylus. Nevertheless, there may be some error between the timing of the controller 108 and the stylus device. Thus, some buffer period between the stylus scan and touch scan might be necessary. For example, FIG. 11 illustrates a ⅛ period buffer between the stylus scan and the touch scan.

### Conclusion

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a controller configured to operatively couple to a sensor, the sensor including a plurality of drive electrodes and a plurality of sense electrodes, a plurality of nodes formed at intersections of the plurality of drive electrodes and the plurality of sense electrodes, touch panel controller comprising:
output circuitry operatively coupled to the plurality of drive electrodes, the output circuitry configured to generate a first drive signal for a first drive electrode of the plurality of drive electrodes and generate a second drive signal for a second drive electrode of the plurality of drive electrodes, the first drive signal different from the second drive electrode; and
input circuitry operatively coupled to the plurality of sense electrodes, the input circuitry configured to measure mutual-capacitance formed at each intersection of the plurality of drive electrodes and of the plurality of sense electrodes to create an image of one or more objects proximate to the sensor.

2. The apparatus as recited in claim 1, wherein a frequency characteristic of the first drive signal is orthogonal to a frequency characteristic of the second drive signal.

3. The apparatus as recited in claim 1, wherein the output circuitry is configured to generate a third drive signal for a third drive electrode of the plurality of drive electrodes, the third drive signal different from the first drive signal and the second drive signal.

4. The apparatus as recited in claim 3, wherein a frequency characteristic for the third drive signal is orthogonal to a frequency characteristic of the first drive signal and a frequency characteristic of the second drive signal.

5. The apparatus as recited in claim 1, wherein the one or more objects comprises a stylus device.

6. The apparatus as recited in claim 1, wherein the output circuitry comprises a frequency generator configured to generate a plurality of drive signals, a plurality of digital-to-analog converters communicatively coupled to the frequency generator, a plurality of buffers, each buffer of the plurality of buffers coupled to a respective digital-to-analog converter of the plurality of digital-to-analog converters, each buffer coupled to a respective drive electrode of the plurality of drive electrodes.

7. The apparatus as recited in claim 1, wherein the sensor comprises a touch panel sensor.

8. The apparatus as recited in claim 1, wherein the sensor comprises a fingerprint sensor.

9. The apparatus as recited in claim 1, wherein the event comprises at least one of a touch event, a stylus engaging with the sensor, or a fingerprint interfacing with the sensor.
